(19) United States
(12) Patent Application Publication
(10) Pub. No.: US 2025/0111257 A1
(43) Pub. Date: Apr. 3, 2025

(54) Generating Different Sampling Orders of Random Variables in a Bayesian Model for Markov Chain Monte Carlo Sampling Techniques

(71) Applicant: Oracle International Corporation, Redwood City, CA (US)

(72) Inventor: Daniel Goodman, Bagillt (GB)

(21) Appl. No.: 18/478,822

(22) Filed: Sep. 29, 2023

(51) Int. Cl. G06N 7/01

(52) U.S. Cl. CPC G06N 7/01

(57) ABSTRACT

Different sampling orders of random variables in a Bayesian model may be generated for Markov Chain Monte Carlo sampling techniques. Code may be received that causes a Markov Chain Monte Carlo sampling technique to be performed with respect to a Bayesian model that includes random variables representing different parameterized probability distributions and connected via edges in a Directed Acyclical Graph (DAG). Instructions may be generated to execute the code that cause the Markov Chain Monte Carlo sampling technique, the instructions including performing different orders for sampling different random variables in the DAG in different iterations of the Markov Chain Monte Carlo sampling technique.

### BACKGROUND

### Field of the Disclosure

This disclosure relates to techniques for inferring the values of samples from random variables in Bayesian models.

### Description of the Related Art

Baysesian models are are increasingly employed to implement decision making in applications or perform analysis. For example, various different systems may utilize a Bayesian model inference to make a control decision in a larger workflow for accomplishing various tasks. Because the performance of inferences made by Bayesian models impacts the performance of a system, service, or application that deploys the Bayesian model, techniques for sampling random variables of Bayesian models may be investigated.

### SUMMARY

Techniques for sampling Bayesian models utilizing different orders for sampling random variables in different iterations of the sampling technique may be implement. An application, system, or service that performs Markov Chain Monte Carlo sampling in order to make an inference or perform some other analysis using a Bayesian model may sample the Bayesian model in iterative fashion. For each iteration of sampling the Bayesian model, a determined ordering of sampling the random variables may be used which differs from an ordering used in another sampling iteration. Code that invokes a Markov Chain Monte Carlo sampling technique may be compiled or otherwise considered to generate instructions that perform the different orders for sampling different random variables in different iterations of the Markov Chain Monte Carlo sampling technique.

### BRIEF DESCRIPTION OF THE DRAWINGS

FIG. 1 is a logical block diagram of an example Markov blanket for a sampling a Bayesian model, according to some embodiments.

FIG. 2 is a logical block diagram illustrating the generation of instructions for performing Markov Chain Monte Carlo sampling techniques that use different sampling orders of random variables in a Bayesian model, according to some embodiments.

FIG. 3 illustrates an example of a chain of random variables in a sampling technique according to some embodiments.

FIG. 4 is a flow diagram illustrating methods and techniques for compiling a probabilistic model to target a language, according to some embodiments.

FIG. 5 is a flow diagram illustrating methods and techniques for generating different sampling orders of random variables in a Bayesian model for Markov Chain Monte Carlo sampling techniques, according to some embodiments.

FIG. 6 illustrates an example computing system, according to some embodiments.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (e.g., meaning having the potential to) rather than the mandatory sense (e.g. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Various techniques for generating different sampling orders of random variables in a Bayesian model for Markov Chain Monte Carlo sampling techniques are described herein. Bayesian models include a set of random variables representing different parameterized probability distributions. Bayesian models may be defined as a Directed Acyclical Graph (DAG), as the relationships between the random variables cannot be cyclical (e.g., directed edges representing the relationships starting at a given vertex may not lead back to that given vertex). Each random variable in a Bayesian model can be sampled one or more times to get values from the parameterized probability distributions. The random variables can be parameterized with values sampled from other random variables.

Bayesian models support techniques for generating inferences or performing other data analyses that can provide alternatives to other types of machine learning models, which may be less effective in some scenarios. For example, in low-data domains, other machine learning techniques, such as deep learning using artificial neural networks, may generate low accuracy predictions as the amount of data available may be insufficient to train the artificial neural networks. Additionally, Bayesian models also offer greater interpretive insights into the generation of inferences. For example, unlike artificial neural network models, Bayesian models explicitly model relationships between variables (e.g., in the DAG).

In order to employ Bayesian models, different sampling techniques may be used. For example, iterative sampling techniques such as Markov Chain Monte Carlo sampling techniques, including Gibbs sampling or other Metropolis-Hastings based techniques, may be used to generate possible values from sampled variables in a Bayesian model. The sample values can be used for many purposes including approximating the distributions of random variables in the models and approximating the values of latent variables in the models.

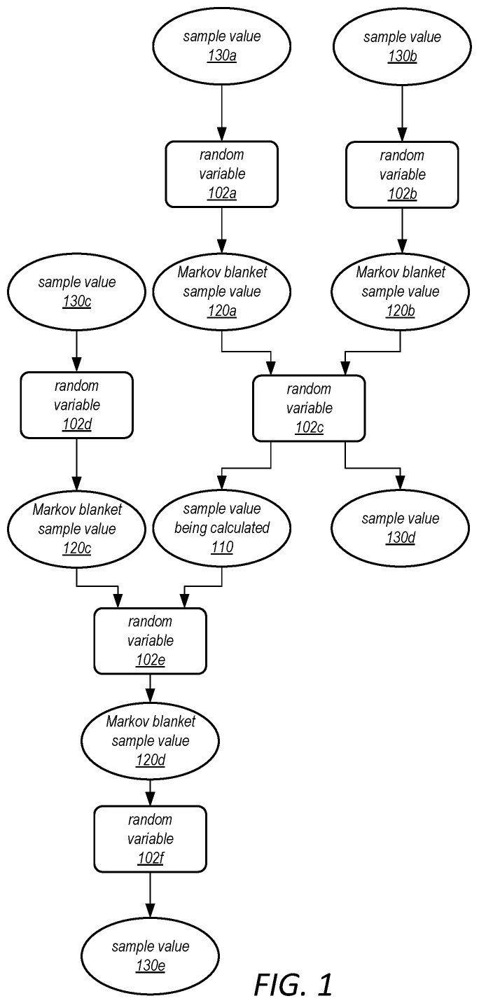

Consider, as an example, the Gibbs sampling technique. The Gibbs sampling technique may be described as:
1. Initialize the unconditioned sample variables in the Bayesian model to values in the distributions they are drawn from
2. Progress from iteration i to iteration i+1 by taking each sample value in the model in turn and calculating a new value for it based on the values in its Markov blanket. These values consist of:
   i. The sample values that are used as input parameters to the random variable this sample variable was drawn from.
   ii. The sample variables that are used as other inputs to any random variables this sample variable is a parameter too.
   iii. The sample variables sampled from any random variables this sample variable is a parameter too.
Any example of this set of sample values are shown in FIG. 1. When a conditioned value is available that value should be used, otherwise the value from i+1th iteration if available, otherwise use the value from the ith iteration.
3. Repeat step 2 k times to generate k samples for each uncoditioned variable.

FIG. 1 is a logical block diagram of an example Markov blanket for a sampling a Bayesian model, according to some embodiments. In the illustrated example, an ordering of sampling random variables 102a, 102b, 102c, 102d, 102e, and 102f, is shown. For a sample value being calculated 110, a Markov blanket is determined, such that sample values 120a, 120b, 120c, and 120d, are in the Markov blanket (and sample values 130a, 130b, 130c, 130d and 130e are not in the Markov blanket for sample value being calculated 110).

As exemplified by Gibbs sampling, if there is a long path through the DAG that represents the Bayesian model there can be a large number of iterations between sample values changing and the information in the changed value propagating through

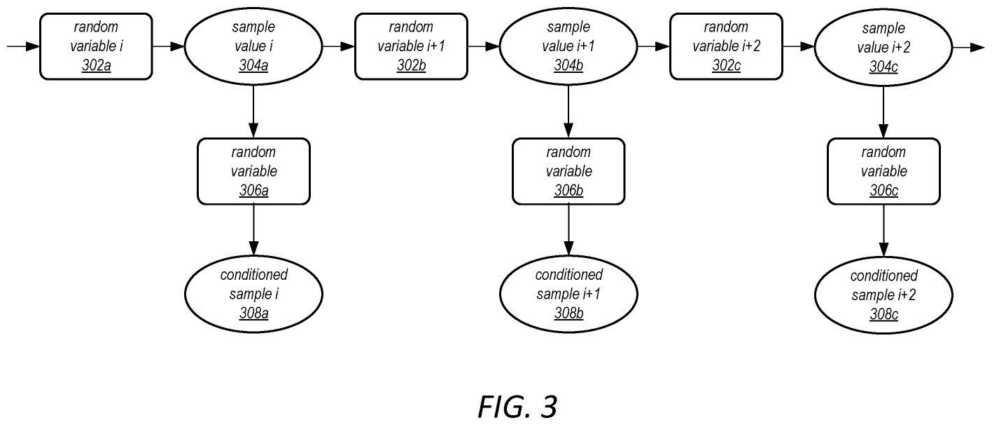

the Bayesian model. For instance, in the Gibbs sampling technique example, if there is a chain of random variables [1 . . . n], each random variable may have a single sample variable drawn from it. The sample variable of the ith random variable may be used as a parameter to the i+1th random variable. The first random variable is parameterized with a constant value. Each of these sample values is also used to parameterize another random variable which has a single sample drawn from it, and the values of these samples are conditioned. FIG. 3, discussed below, provides an example illustration of part of this chain.

When performing a sampling technique like Gibbs sampling, an order of the samples may have to be picked for the sample values to be computed in. If, the values i are sampled in increasing order, each sample i will be evaluated with:
Input data derived from all the inputs [1 . . . i−1].
The conditioned sample i.
The current value of the sample i+1.

Because the sampling technique is only looking at data one link further down the chain, it will not be until the next iteration that data from sample i+2 is included in the calculation of sample i and for sample 1 there is a delay of n iterations between any change in the value of sample n and the result of that iteration reaching sample 1. Reversing order of sampling means sample 1 receives results derived from sample n on the same iteration, but now sample n waits n iterations to receive data derived from sample 1. Accordingly, if for each item in the chain half the values before it in the chain are sampled, before it is sampled and the other half are sampled after, then the best performance for a single sampling ordering is achieved. Sampling patterns may be implemented that can achieve this performance. In one pattern, sample the odd value entries in increasing order, and the even value entries in decreasing order. In another pattern, sample the even value entries in increasing order and the even value entries in decreasing order.

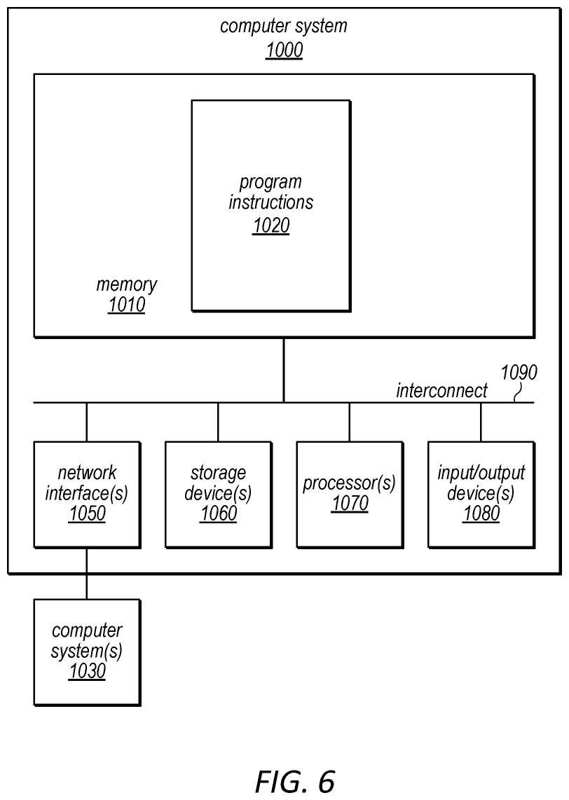

As discussed below, various embodiments of generating different sampling orders of random variables in a Bayesian model for Markov Chain Monte Carlo sampling techniques may reduce the amount of time to perform sampling techniques on Bayesian models. Furthermore, the amount of computing resources (e.g., memory, processor, etc.) used to perform sampling of a Bayesian model may be reduced. It may be appreciated that such techniques lead to improved performance of computing devices implementing such techniques, such as computer system 1000 discussed below with regard to FIG. 6, but also may increase the number of scenarios in which Bayesian models may be deployed in different systems, services, or applications. Accordingly, the benefits of utilizing Bayesian models to generate inferences or perform data analyses can be more widely adopted, improving the performance of the different systems, services, or applications that can more efficiently make use of Bayesian models.

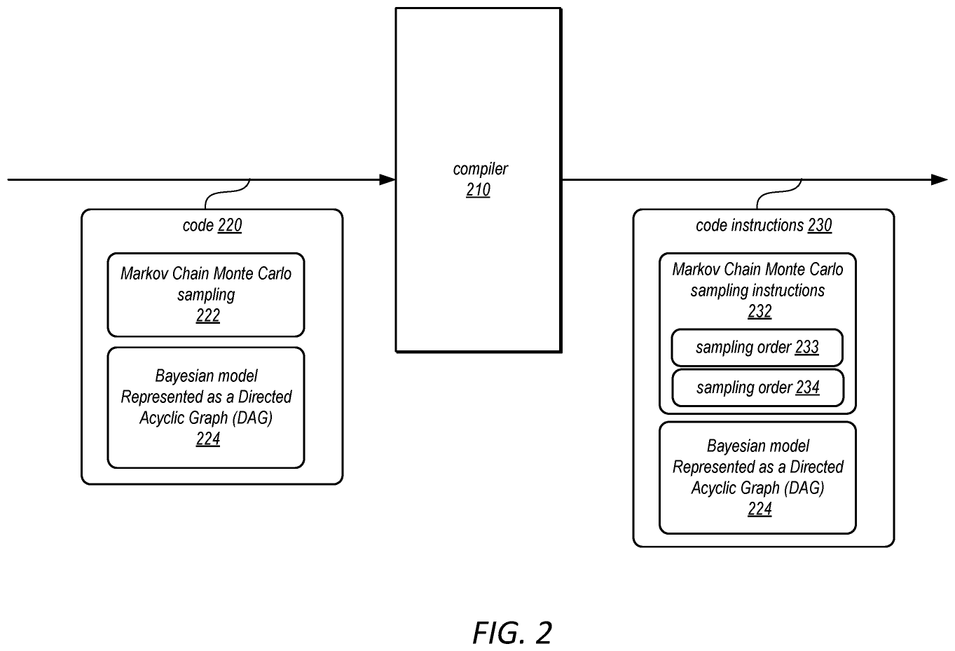

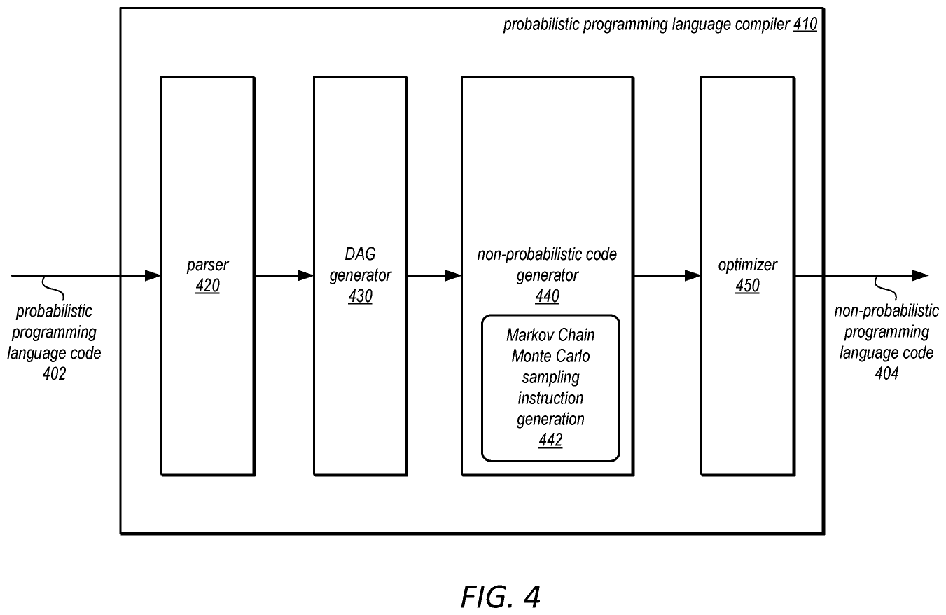

FIG. 2 is a logical block diagram illustrating the generation of instructions for performing Markov Chain Monte Carlo sampling techniques that use different sampling orders of random variables in a Bayesian model, according to some embodiments. Compiler 210 may be implemented as a standalone compiler on a single system or as part of a larger service, such as service accessed via network requests to a server or other computing resource hosted by a cloud computing provider. Compiler 210 may be implemented on a computing system, such as computing system 1000 discussed below with regard to FIG. 6. Compiler 210 may be a programming language compiler that supports generating executable instructions (e.g., assembly or other low-level programming language code) or code translated or interpreted into a different programming language (e.g., the generation of non-probabilistic programming language code from probabilistic programming language code as discussed below with regard to FIG. 4). Code 220 may include the invocation of a Markov Chain Monte Carlo sampling technique 222 (e.g., utilizing a software library that implements the Markov Chain Monte Carlo sampling technique). Code 220 may also describe or reference a Bayesian model represented as a DAG 224.

Compiler 210 may implementing techniques to plan, optimize, or otherwise generate code instructions 230 that include Markov Chain Monte Carlo sampling instructions 232 that utilize different sampling orders 233 and 234 for different (e.g., alternating) iterations when performing the Markov Chain Monte Carlo sampling instructions 232 with respective to Bayesian model 224. As the Bayesian model can be represented as a DAG, there exists a partial order for all the samples in the DAG.

Compiler 210 may pick an ordering such that all samples in the model are evaluated only after all the samples they are dependent on have been evaluated for one iteration. Then, compiler 210 may reverse the requirement for the following iteration. In this way, propagation delay may be reduced to 2 iterations.

Although FIG. 2, illustrates the use of a probabilistic programming language compiler to generate code instructions that utilize different sampling orders of random variables in a Bayesian model, in other embodiments, a software library or other software component may be invoked (e.g., via a function call) by a probabilistic programming language that takes a DAG as input to perform an inference. The software library may already include as part of its implementing code, instructions that utilize different sampling orders to perform the inference when requested.

For example, FIG. 3 illustrates an example of a chain of random variables in a sampling technique according to some embodiments. In the example chain, random variables (i, i+1, and i+2), indicated at 302a, 302b, and 302c, are sampled and used to parameterize the next random variable to produce sample values (i, i+1, and i+2), indicated at 304a, 304b, and 304c, as well as condition samples (i, i+1, and i+2), indicated at 308a, 308b and 308c, through random variables 306a, 306b, and 306c. According to the ordering selection techniques noted above, in this illustrated example, in odd iterations of the sampling technique, the samples may be evaluated 1 forward to n, and on even iterations the samples may be evaluated n backward to 1.

FIG. 4 is a logical block diagram of a probabilistic programming language compiler, according to some embodiments. Probabilistic programming language compiler 410 may be implemented as a standalone compiler on a single system or as part of a larger service, such as service accessed via network requests to a server or other computing resource hosted by a cloud computing provider. FIG. 6 illustrates an example computing system 1000 upon which probabilistic programming language compiler 410 may be implemented.

One example arrangement of components that probabilistic programming language model compiler may implement is shown in FIG. 4. Probabilistic programming language code 402 is received (e.g., entered via a text editor or other interface or uploaded or otherwise provided as one or more files to probabilistic programming language compiler 410). A parser, such as parser 420, may perform one or more parsing techniques to evaluate code 402 and may tokenize or represent the probabilistic programming language as one or more data structures for later processing (e.g., abstract symbol trees).

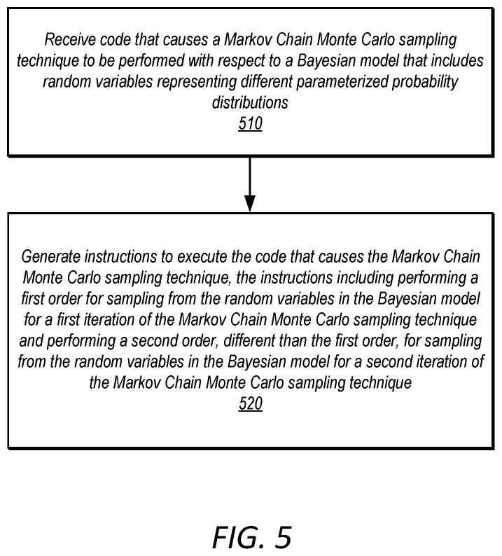

DAG generator 430 may evaluate the output of parser 420 to generate a DAG for a Bayesian model described in code 402. Non-probabilistic code generator 440 may perform a first pass or first version generation of code in a non-probabilistic programming language using various techniques. In at least some embodiments, non-probabilistic code generator 440 may recognize invocations of a Markov Chain Monte Carlo sampling technique and perform Markov Chain Monte Carlo sampling instruction generation according to the techniques discussed above with regard to FIGS. 2 and 3 and below with regard to FIG. 5. Optimizer 450 may implement various techniques for transforming or otherwise optimizing the performance of the non-probabilistic code, in some embodiments. The non-probabilistic programming language code 404 can then be provided for further display, editing, or compilation and execution, in various embodiments.

FIG. 5 is a flow diagram illustrating methods and techniques for generating different sampling orders of random variables in a Bayesian model for Markov Chain Monte Carlo sampling techniques, according to some embodiments. As indicated at 510, code may be received that causes a Markov Chain Monte Carlo sampling technique to be performed with respect to a Bayesian model that includes random variables representing different parameterized probability distributions, in some embodiments. In some embodiments, the random variables may be represented as (or converted into) nodes in a Directed Acyclical Graph (DAG). In some embodiments, the random variables may be represented as string naming variables (e.g., instead of as nodes in a DAG or other data structure).

For example, a compiler, such as compiler 210 or probabilistic programming language compiler 410, may receive code, specified in various programming languages, including probabilistic programming languages, that invokes one of various iterative Markov Chain Monte Carlo sampling techniques, such as Gibbs sampling or other forms of Metropolis-Hastings sampling techniques. The code may reference the Bayesian model that is stored or described separately from the code, in some embodiments. In some embodiments, the code may specify or describe the Bayesian model directly, such as when the code is specified in a probabilistic programming language. In another example, the code may be a software library or other software component that is invoked (e.g., via a function call) and that accepts, as input, a representation of the Bayesian model (e.g., a DAG) to perform an Markov Chain Monte Carlo sampling.

As indicated at 520, instructions may be generated to execute the code that causes the Markov Chain Monte Carlo sampling technique, in some embodiments. For example, the instructions may identify a starting point and direction for traversing the random variables in the DAG of the Bayesian model in order to determine an ordering such that all samples in the Bayesian model are evaluated only after all the samples they are dependent on have been evaluated for one iteration construct a chain of random variables to sample and then parameterize the next random variable (e.g., similar to the chain depicted in FIG. 2). The technique for traversing the DAG to determine the ordering may be dependent on the Markov Chain Monte Carlo sampling technique used (e.g., Gibbs, Metropolis-Hastings, etc.). Once the first ordering is determined, a second ordering may be determined that is different than the first ordering (e.g., a reverse ordering of the first ordering) in order to reduce the propagation delay. While two orderings are discussed in the examples above, more than two orderings could be used in sampling iterations (e.g., rotating between n orderings every n iterations). In some embodiments, the same random variables may be sampled in each ordering, whereas in other embodiments, different ones of the random variables could be sampled for some or all orderings (e.g., by randomly dropping one or more random variables from sampling in an iteration).

The code may also include instructions that utilize a result of the sampling technique. For example, in some embodiments, an inference or other analysis result, which may be used in downstream processing of a system, service, or application, may be generated based on a result of the sampling technique that uses different orderings for sampling random variables in different iterations of the sampling technique.

FIG. 6 illustrates a computing system configured to implement the methods and techniques described herein, according to various embodiments. The computer system 1000 may be any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc., or in general any type of computing device.

The mechanisms for generating different sampling orders of random variables in a Bayesian model for Markov Chain Monte Carlo sampling techniques, as described herein, may be provided as a computer program product, or software, that may include a non-transitory, computer-readable storage medium having stored thereon instructions, which may be used to program a computer system (or other electronic devices) to perform a process according to various embodiments. A non-transitory, computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

In various embodiments, computer system 1000 may include one or more processors 1070; each may include multiple cores, any of which may be single or multi-threaded. Each of the processors 1070 may include a hierarchy of caches, in various embodiments. The computer system 1000 may also include one or more persistent storage devices 1060 (e.g. optical storage, magnetic storage, hard drive, tape drive, solid state memory, etc.) and one or more system memories 1010 (e.g., one or more of cache, SRAM, DRAM, RDRAM, EDO RAM, DDR 10 RAM, SDRAM, Rambus RAM, EEPROM, etc.). Various embodiments may include fewer or additional components not illustrated in FIG. 6 (e.g., video cards, audio cards, additional network interfaces, peripheral devices, a network interface such as an ATM interface, an Ethernet interface, a Frame Relay interface, etc.).

The one or more processors 1070, the storage device(s) 1050, and the system memory 1010 may be coupled to the system interconnect 1040. One or more of the system memories 1010 may contain program instructions 1020. Program instructions 1020 may be executable to implement various features described above, including compilers or other systems or applications that generate or use different sampling orders of random variables in a Bayesian model for Markov Chain Monte Carlo sampling techniques, in some embodiments as described herein. Program instructions 1020 may be encoded in platform native binary, any interpreted language such as Java™ byte-code, or in any other language such as C/C++, Java™, etc. or in any combination thereof. System memories 1010 may also contain LRU queue(s) 1026 upon which concurrent remove and add-to-front operations may be performed, in some embodiments.

In one embodiment, Interconnect 1090 may be configured to coordinate I/O traffic between processors 1070, storage devices 1070, and any peripheral devices in the device, including network interfaces 1050 or other peripheral interfaces, such as input/output devices 1080. In some embodiments, Interconnect 1090 may perform any necessary protocol, timing or other data transformations to convert data signals from one component (e.g., system memory 1010) into a format suitable for use by another component (e.g., processor 1070). In some embodiments, Interconnect 1090 may include support for devices attached through various types of peripheral buses, such as a variant of the Peripheral Component Interconnect (PCI) bus standard or the Universal Serial Bus (USB) standard, for example. In some embodiments, the function of Interconnect 1090 may be split into two or more separate components, such as a north bridge and a south bridge, for example. In addition, in some embodiments some or all of the functionality of Interconnect 1090, such as an interface to system memory 1010, may be incorporated directly into processor 1070.

Network interface 1050 may be configured to allow data to be exchanged between computer system 1000 and other devices attached to a network, such as other computer systems, or between nodes of computer system 1000. In various embodiments, network interface 1050 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1080 may, in some embodiments, include one or more display terminals, keyboards, keypads, touchpads, scanning devices, voice or optical recognition devices, or any other devices suitable for entering or retrieving data by one or more computer system 1000. Multiple input/output devices 1080 may be present in computer system 1000 or may be distributed on various nodes of computer system 1000.

In some embodiments, similar input/output devices may be separate from computer system 1000 and may interact with one or more nodes of computer system 1000 through a wired or wireless connection, such as over network interface 1050.

Those skilled in the art will appreciate that computer system 1000 is merely illustrative and is not intended to limit the scope of the methods for providing enhanced accountability and trust in distributed ledgers as described herein. In particular, the computer system and devices may include any combination of hardware or software that may perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 800 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed:

1. A system, comprising:
at least one processor;
a memory, comprising program instructions that when executed by the at least one processor cause the at least one processor to implement a system configured to:
receive code that causes a Markov Chain Monte Carlo sampling technique to be performed with respect to a Bayesian model comprising a plurality of random variables, representing different parameterized probability distributions and connected via edges in a directed acyclical graph; and
evaluate the directed acyclical graph to determine a first order for sampling from the plurality of random variables for a first iteration of the Markov Chain Monte Carlo sampling technique and performing a second order, different than the first order, for sampling from the plurality of random variables for a second iteration of the Markov Chain Monte Carlo sampling technique;
generate instructions to execute the code that causes the Markov Chain Monte Carlo sampling technique, wherein the instructions comprise performing the first order and the second order for different respective iterations of the Markov Chain Monte Carlo sampling technique; and
perform the instructions to execute the code.

2. The system of claim 1, wherein the Markov Chain Monte Carlo sampling technique is a Gibbs sampling technique.

3. The system of claim 1, wherein the second order is a reverse of the first order.

4. The system of claim 1, wherein the code that causes the Markov Chain Monte Carlo sampling technique to be performed also generates an inference for a given input value.

5. The system of claim 1, wherein the first order is performed on odd numbered iterations of the Markov Chain Monte Carlo sampling technique and wherein the second order is performed on even numbered iterations of the Markov Chain Monte Carlo sampling technique.

6. The system of claim 1, wherein the Markov Chain Monte Carlo sampling technique is a Metropolis Hastings sampling technique.

7. A method, comprising:
performing, by one or more computing devices:
receiving code that causes a Markov Chain Monte Carlo sampling technique to be performed with respect to a Bayesian model comprising a plurality of random variables, representing different parameterized probability distributions; and
generating instructions to execute the code that causes the Markov Chain Monte Carlo sampling technique, wherein the instructions comprise performing a first order for sampling from the plurality of random variables for a first iteration of the Markov Chain Monte Carlo sampling technique and performing a second order, different than the first order, for sampling from the plurality of random variables for a second iteration of the Markov Chain Monte Carlo sampling technique.

8. The method of claim 7, wherein the Markov Chain Monte Carlo sampling technique is a Gibbs sampling technique.

9. The method of claim 7, wherein the second order is a reverse of the first order.

10. The method of claim 7, wherein the code that causes the Markov Chain Monte Carlo sampling technique to be performed generates an inference for a given input value.

11. The method of claim 7, wherein the first order is performed on odd numbered iterations of the Markov Chain Monte Carlo sampling technique and wherein the second order is performed on even numbered iterations of the Markov Chain Monte Carlo sampling technique.

12. The method of claim 7, wherein the code is specified in a probabilistic programming language and wherein the instructions are generated in a non-probabilistic programming language.

13. The method of claim 7, wherein the Markov Chain Monte Carlo sampling technique is a Metropolis Hastings sampling technique.

14. One or more non-transitory, computer-readable storage media, storing program instructions that when executed on or across one or more computing devices, cause the one or more computing devices to implement:
receiving code that causes a Markov Chain Monte Carlo sampling technique to be performed with respect to a Bayesian model comprising a plurality of random variables, representing different parameterized probability distributions; and
evaluating the plurality of random variables of the Bayesian model to determine a first order for sampling from the plurality of random variables for a first iteration of the Markov Chain Monte Carlo sampling technique and performing a second order, different than the first order, for sampling from the plurality of random variables for a second iteration of the Markov
generating instructions to execute the code that causes the Markov Chain Monte Carlo sampling technique, wherein the instructions comprise performing the first order and the second order for different respective iterations of the Markov Chain Monte Carlo sampling technique.

15. The one or more non-transitory, computer-readable storage media of claim 14, wherein the Markov Chain Monte Carlo sampling technique is a Gibbs sampling technique.

16. The one or more non-transitory, computer-readable storage media of claim 14, wherein the second order is a reverse of the first order.

17. The one or more non-transitory, computer-readable storage media of claim 14, wherein the code that causes the Markov Chain Monte Carlo sampling technique to be performed generates an inference for a given input value.

18. The one or more non-transitory, computer-readable storage media of claim 14, wherein the first order is performed on odd numbered iterations of the Markov Chain Monte Carlo sampling technique and wherein the second order is performed on even numbered iterations of the Markov Chain Monte Carlo sampling technique.

19. The one or more non-transitory, computer-readable storage media of claim 14, wherein the code is specified in a probabilistic programming language and wherein the instructions are generated in a non-probabilistic programming language.

20. The one or more non-transitory, computer-readable storage media of claim 14, wherein the Markov Chain Monte Carlo sampling technique is a Metropolis Hastings sampling technique.
